(19) United States
(12) Patent Application Publication
(10) Pub. No.: US 2018/0053368 A1
(43) Pub. Date: Feb. 22, 2018

(54) FOOD DISPENSING DEVICE

(71) Applicant: HON HAI PRECISION INDUSTRY CO., LTD., New Taipei (TW)

(72) Inventor: CHEN-YANG KUO, New Taipei (TW)

(21) Appl. No.: 15/469,648

(22) Filed: Mar. 27, 2017

(30) Foreign Application Priority Data
Aug. 22, 2016 (CN) 201610698769.4

(51) Int. Cl. G07F 9/10; G07F 11/46; G07F 11/50; G07F 11/56

(52) U.S. Cl. CPC G07F 9/10; G07F 11/56; G07F 11/50; G07F 11/46

(57) ABSTRACT

A food dispensing device includes a shell and a safety door secured on the shell. The shell includes a base and a cover secured on the base. The base and the cover together define an opening. The safety door includes a securing portion received in the opening, and a sliding portion received in the opening. The sliding portion includes a board and a driving module, the driving module includes a driving device secured on the shell and a driving shaft rotatably installed on the board. The driving device rotates the driving shaft, the driving shaft rotates to slide the board upward or downward relative to the driving shaft to open or close the opening.

### CROSS-REFERENCE TO RELATED APPLICATIONS

This application claims priority to Chinese Patent Application No. 201610698769.4 filed on Aug. 22, 2016 the contents of which, are incorporated by reference herein.

### FIELD

The subject matter herein generally relates to food dispensing devices.

### BACKGROUND

With advances in science and technology, various dispensing devices are being explored to provide consumers with new functions and products. Among the various dispensing devices being further developed is a food dispensing device. Generally, a food dispensing device includes a safety door that is slidably installed on the front end of the dispensing device. A driving device is secured on both sides of the safety door and configured to open or close the safety door.

### BRIEF DESCRIPTION OF THE DRAWINGS

Implementations of the present disclosure will now be described, by way of example only, with reference to the attached figures.

FIG. 1 is an exploded, isometric view of an exemplary embodiment of a food dispensing device.

FIG. 2 is an enlarged view of circle II in FIG. 1.

FIG. 3 is another exploded, isometric view of the food dispensing device of FIG. 1.

FIG. 4 is an assembled, isometric view of a board and a driving shaft of the food dispensing device of FIG. 1.

FIG. 5 is an assembled, isometric view of the food dispensing device of FIG. 1 with a safety door being closed.

FIG. 6 is another assembled, isometric view of the food dispensing device of FIG. 5.

FIG. 7 is an assembled, isometric view of the food dispensing device of FIG. 1 with a safety door being open.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

Several definitions that apply throughout this disclosure will now be presented.

The term “outside” refers to a region that is beyond the outermost confines of a physical object. The term “inside” indicates that at least a portion of an object is contained within a boundary formed by another object. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

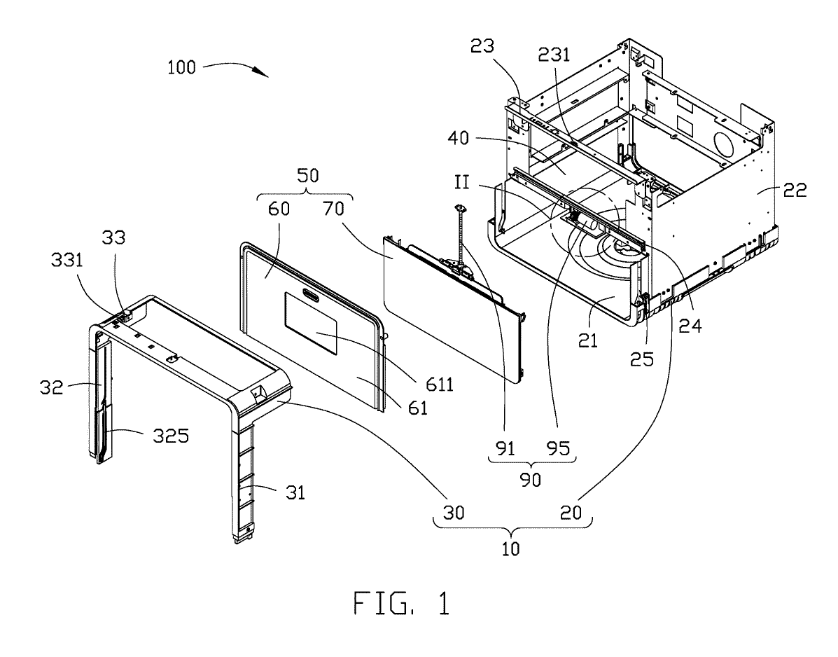

FIG. 1 illustrates one exemplary embodiment of a food dispensing device 100. The food dispensing device 100 includes a shell 10 and a safety door 50 slidably installed on the shell 10.

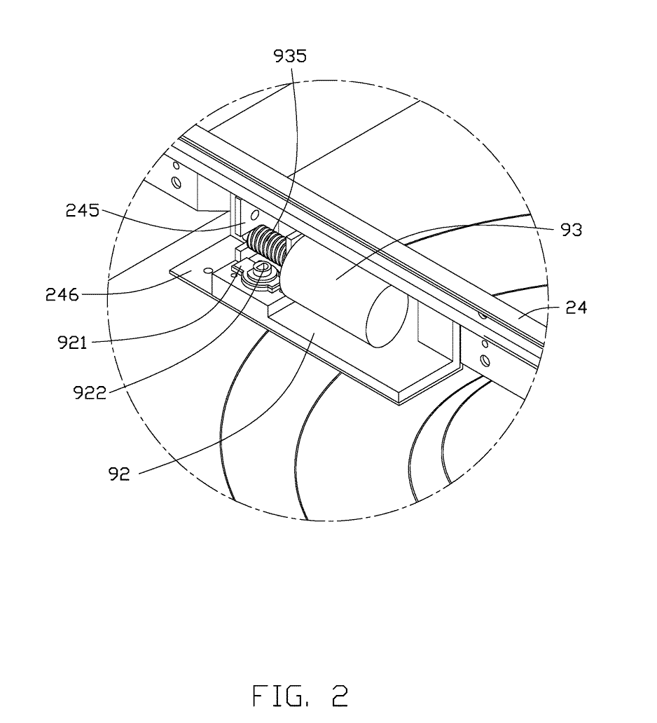

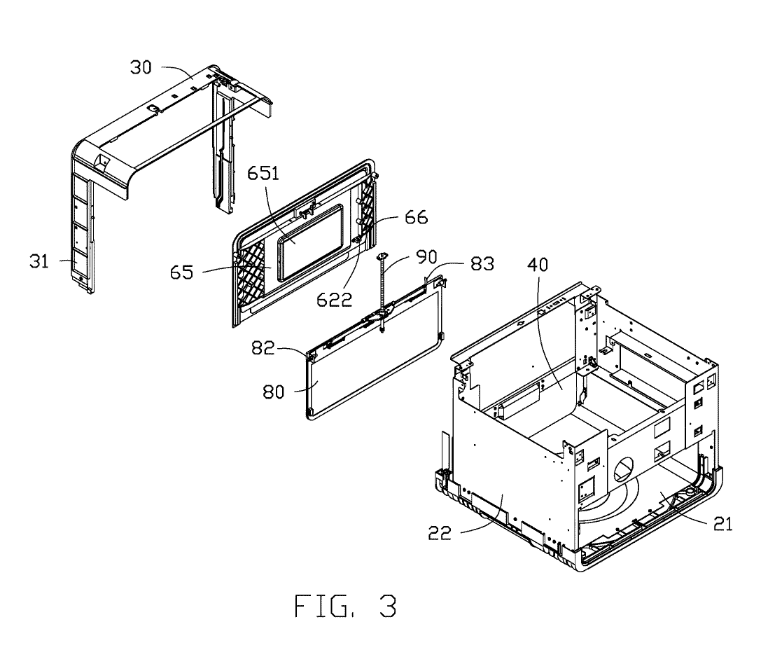

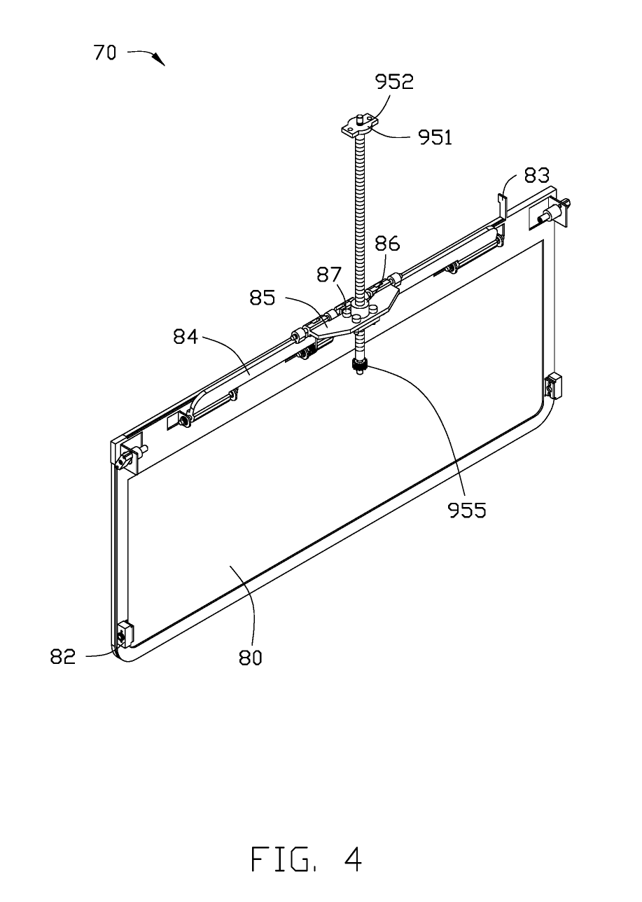

FIGS. 1 to 4 illustrate that the shell 10 includes a base 20 and a cover 30 secured on the base 20. The front end of the base 20 and the front end of the cover 30 together define an opening 40. The opening 40 is configured to conveniently provide removal of food from the food dispensing device 100.

The base 20 includes a bottom plate 21 and two sidewalls 22 connected with the sides of the bottom plate 21. The top edge of one end of each sidewall 22 adjacent to the opening 40 is provided with a supporting plate 23. The middle portion of the supporting plate 23 defines a gap 231. The middle portion of one end of each sidewall 22 adjacent to the opening 40 is provided with a mounting plate 24. The mounting plate 24 is located under the supporting plate 23. The mounting plate 24 is provided with a mounting portion 245 towards the safety door 50. The bottom of the mounting portion 245 is provided with a pallet 246. The bottom edge of one end close to the opening 40 of each sidewall 22 is provided with slide rail 25. The bottom end of the sliding rail 25 is bent towards the safety door 50.

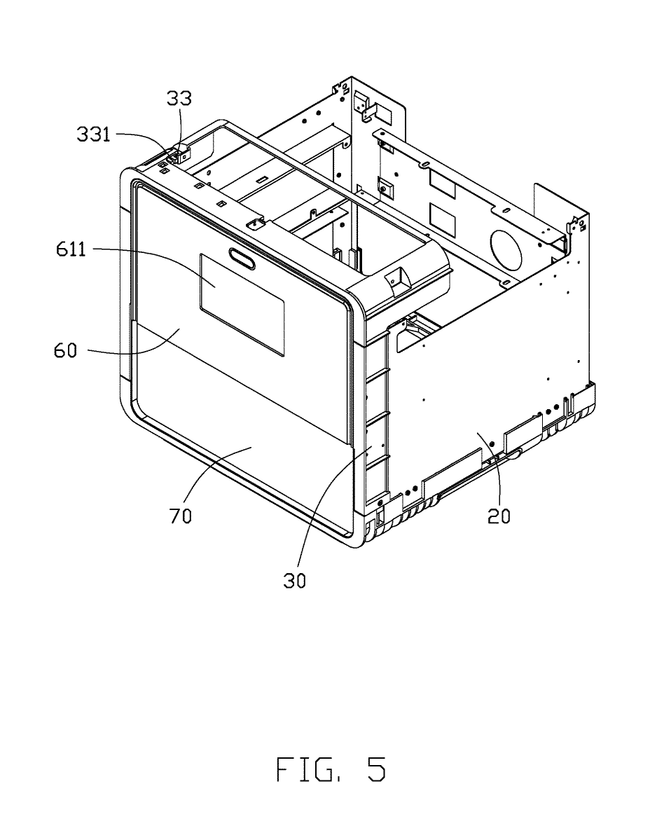

Parallel columns 31 are defined at the sides of the front end of the cover 30. The columns 31 are connected with the sidewalls 22 of the base 20. Each column 31 includes a bracket 32 at each side of the cover 30, the brackets 32 face each other. The top end of each bracket 32 and the bottom end of each bracket 32 each have a rail 325. The bottom end of each rail 325 is bent towards the safety door 50, and the lower rail 325 corresponds to the slide rail 25 of the sidewall 22. The cover 30 is provided with a first inductor 33 (shown in FIG. 5) above one of the brackets 32. The first inductor 33 is provided with a vertical slot 331, and the slot 331 is substantially in the same line as the rail 325.

FIGS. 1 to 4 illustrate that the safety door 50 includes a securing portion 60 received in the opening 40 and a sliding portion 70 received in the opening 40. The securing portion 60 includes a front face 61 and a back face 65 opposite to the front face 61. The front face 61 is provided with a touch panel 611 configured to operate the food dispensing device 100. The back face 65 is provided with a processing module 651, and the processing module 651 can process signals from the touch panel 611. The bottom end of the back face 65 is provided with a second inductor 66. The second inductor 66 is provided with a vertical slot 662.

The sliding portion 70 includes a board 80 and a driving module 90, the driving module 90 is configured to slide the board 80. Each side of the board 80 is provided with a limiting shaft 82. The limiting shaft 82 can be slid in the slide rail 25 and the rail 325 to slide the sliding portion 70 along the sides of the cover 30 adjacent to the opening 40. The top end of one side of the board 80 is provided with an induction plate 83, and the induction plate 83 can be inserted into slot 662 of the second inductor 66. The top end of the board 80 is further provided with a connecting plate 84. A latch plate 85 is rotatably installed on one side of the connecting plate 84. The connecting plate 84 can rotate relative to the latch plate 85. The latch plate 85 defines a gap (not shown), and a hollow shaft sleeve 86 is inserted into the gap and secured on the latch plate 85 by a plurality of securing members 87. The inside of the shaft sleeve 86 is provided with threads.

The driving module 90 includes a driving device 91 received in the mounting portion 245 and a driving shaft 95 attached to the driving device 91. The driving device 91 includes a stand 92 and a motor 93 received in the stand 92. A rotating member 921 is rotatably installed on the stand 92. The rotating member 921 defines a “D” shaped rotating hole 922. One end of the motor 93 is provided with a worm 935. The motor 93 is configured to rotate along a first direction and a second direction opposite to the first direction. The worm 935 is thus driven by motor 93 to rotate along the first direction or the second direction. The interior of the motor 93 is provided with a chip (not shown) configured to receive the signals from the processing module 651 to control the motor 93. A predetermined value is set in the chip. When the output power of the motor rotating along the second direction exceeds the predetermined value, the chip will control the motor to reverse and rotate along the first direction.

The top end of the driving shaft 95 is provided with a positioning member 951. The middle portion of the positioning member 951 defines a pivot hole 952. The positioning member 951 is secured above the supporting plate 23 by a plurality of fixing members (not shown). The top end of the driving shaft 95 can pass through the gap 231 of the supporting plate 23 to be inserted into the pivot hole 952. Thus, the driving shaft 95 is rotatably installed on the positioning member 951. The driving shaft 95 can pass through the shaft sleeve 86. The outside of the driving shaft 95 is provided with threads, and the outer or external threads are engaged with the internal threads of the shaft sleeve 86. The driving shaft 95 can rotate to drive the shaft sleeve 86 to rotate relative to the driving shaft 95.

The bottom end of the driving shaft 95 is “D” shaped and is configured to be inserted into the rotating hole 922. The driving shaft 95 is provided with a turbine 955 close to the bottom end of the driving shaft 95. The turbine 955 can be engaged with the worm 935, and the worm 935 can rotate the turbine 955.

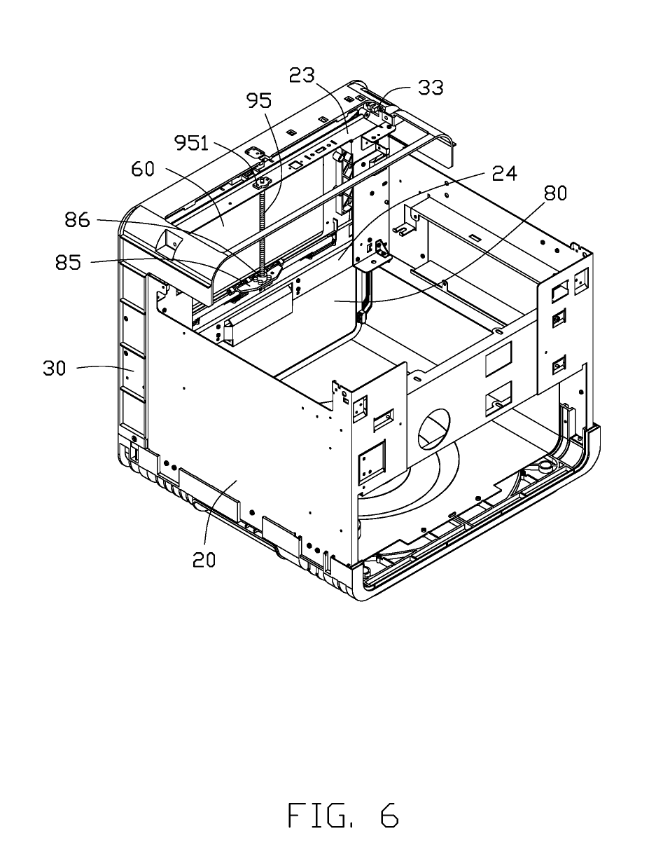

FIGS. 5 and 6 illustrate an exemplary embodiment of the assembly of the food dispensing device 100 of FIG. 1, the cover 30 being secured on the base 20. The securing portion 60 of the safety door 50 is received in the opening 40. The motor 93 is secured on the stand 92, and the driving device 91 is secured on the mounting portion 245 of the mounting plate 24. The stand 92 is placed on the pallet 246, and the positioning member 951 is secured on the supporting plate 23. The pivot hole 925 is aligned with gap 231 of the supporting plate 23, and the top end of the driving shaft 95 passes through the gap 231 to be rotatably installed on the pivot hole 952.

The limiting shaft 82 of each end of the board 80 is inserted into the slide rail 25 of the sidewall 22 and the rail 325 of the bracket 32. Thus, the board 80 is slidably installed on the shell 10. The driving shaft 95 passes through the shaft sleeve 86 to be rotatably installed on the latch plate 85. A bottom end of the driving shaft 95 is inserted into the rotating hole 922 to rotatably install the bottom end of the driving shaft 95 on the rotating member 921. The turbine 955 is engaged with the worm 935. The board 80 is slid to allow the induction plate 83 to be inserted into the slot 662 of the second inductor 66. Thus, the food dispensing device 100 is assembled.

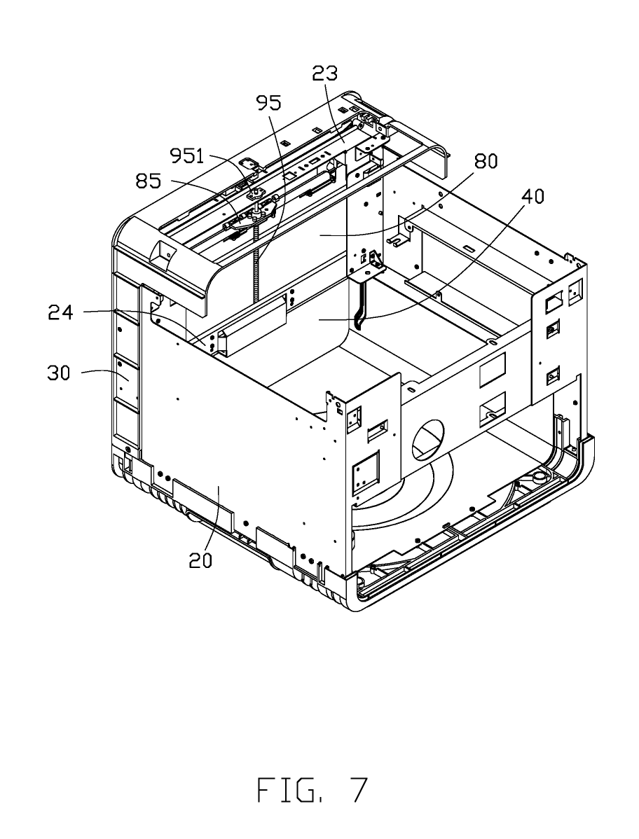

FIGS. 6 and 7 illustrate an exemplary embodiment of the opening of the safety door 50. Once, the touch panel 611 is touched, the processing module 651 transmits the first signal to the chip within the motor 93. The chip activates the motor 93 and the motor 93 is rotated along the first direction after the first signal is received. The worm 935 rotates along the first direction to drive the turbine 955 and rotate the driving shaft 95. The external threads of the driving shaft 95 are engaged with the internal threads of the shaft sleeve 86 to rotate the shaft sleeve 86 and cause the shaft sleeve 86 to slide upward along the driving shaft 95. The latch plate 85 is slid upward along the driving shaft 95 under the driving of the shaft sleeve 86, and the board 80 is slid upward along the rail 325. When the induction plate 83 of the top end of the board 80 is inserted into the slot 331 of the first inductor 33, the first inductor 33 transmits a signal accordingly to the processing module 651 and the chip, and the motor 93 stops turning. At this time, the safety door 50 is opened.

To close the safety door 50, the touch panel 611 is touched and the processing module 651 transmits a second signal to the chip within the motor 93. The chip activates the motor 93 and the motor 93 is rotated along the second direction. The worm 935 rotates along the second direction to drive the turbine 955 and rotate the driving shaft 95. The external threads of the driving shaft 95 are engaged with the internal threads of the shaft sleeve 86 to rotate the shaft sleeve 86 and cause the shaft sleeve 86 to slide downward along the driving shaft 95. The latch plate 85 is slid downward along the driving shaft 95 under the driving of the shaft sleeve 86, and the board 80 is slid downward along the rail 325. When the limiting shaft 82 slides to the bent end of the slide rail 25 and the rail 325, the board 80 is slid to the securing portion 60. When the induction plate 83 of the top end of the board 80 is inserted into the slot 662 of the second inductor 66, the top end of the sliding portion 70 is abutted against the bottom end of the securing portion 60 to seal the opening 40. The second inductor 66 transmits a signal accordingly to the processing module 651 and the chip, and the motor 93 stops turning. At this time, the safety door 50 is closed.

When the board 80 encounters an obstruction during descending process, the motor 93 requires a greater output power to continue rotating the worm 935 along the second direction. When the output power of the motor 93 exceeds the predetermined and preset value of the chip, the chip controls the motor 93 to reverse and then rotate along the first direction, so that the board stops sliding downward and slides upward to return to its initial position.

The exemplary embodiments shown and described above are only examples. Many details are often found in the art such as the other features of a food dispensing device. Therefore, many such details are neither shown nor described. Even though numerous characteristics and advantages of the present disclosure have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A food dispensing device comprising:
a shell, the shell comprising:
a base; and
a cover secured on the shell, the base and the cover together define an opening;
a safety door comprising;
a securing portion received in the opening; and
a sliding portion received in the opening;
wherein the sliding portion comprises a board and a driving module, the driving module comprises a driving device secured on the shell and a driving shaft rotatably installed on the board, the driving device drives the driving shaft to rotate, the driving shaft rotates to slide the board upward relative to the driving shaft to open the opening or downward relative to the driving shaft to close the opening.

2. The food dispensing device of claim 1, wherein the driving device includes a motor, one end of the motor comprises a worm, a bottom end of the driving shaft includes a turbine engaged with the worm, wherein the worm rotates to drive the turbine and rotates the driving shaft.

3. The food dispensing device of claim 2, wherein the base comprises two sidewalls, a mounting plate is placed between the two sidewalls, and the mounting plate defines a mounting portion for the safety door, wherein the driving device is received in the mounting portion.

4. The food dispensing device of claim 3, wherein a top end of each sidewall is provided with a supporting plate, a middle portion of the supporting plate defines a gap, and a top end of the driving shaft passes through the gap.

5. The food dispensing device of claim 4, wherein the top end of the driving shaft is provided with a positioning member, the positioning member defines a pivot hole and is secured above the supporting plate by a plurality of securing member, the top end of the driving shaft can pass through the gap of the supporting plate to be rotatably installed on the pivot hole of the positioning member.

6. The food dispensing device of claim 1, wherein a top end of the board is provided with a latch plate, and the latch plate is provided with a hollow shaft sleeve, an inside surface of the shaft sleeve defines internal threads, an outside surface of the driving shaft defines external threads, the driving shaft passes through the shaft sleeve such that the internal threads engage with the external threads.

7. The food dispensing device of claim 1, wherein the cover comprises two columns, each column is provided with a bracket, each bracket is provided with two slide rails, and the board slides along the two slide rails.

8. The food dispensing device of claim 7, wherein each side of the board includes a limiting shaft, and the limiting shaft can be inserted into the slide rail for the board to slide along the slide rail.

9. The food dispensing device of claim 1, wherein the driving device includes a chip, and the chip is configured to receive a signal from the processing module secured in the safety door to control the motor to rotate in a first direction.

10. The food dispensing device of claim 9, wherein a predetermined value is set in the chip, and when output power of the motor exceeds the predetermined value, the chip will control the motor to rotate in second direction opposite to the first direction to slide the board to its initial position.

11. A food dispensing device, comprising:
a shell, the shell comprising:
a base; and
a cover secured on the shell, the base and the cover together define an opening;
a safety door comprising;
a securing portion received in the opening; and
a sliding portion received in the opening;
wherein the sliding portion comprises a board and a driving module, the driving module comprises a driving device secured on the shell and a driving shaft rotatably installed on the board, the driving device comprises a motor, one end of the motor comprises a worm, the bottom end of the driving shaft comprises a turbine engaged with the worm, and the worm can rotate to drive the turbine and the driving shaft rotating, to let the board slide upward or downward relative to the driving shaft, to open or close the opening.

12. The food dispensing device of claim 11, wherein the base comprises two sidewalls, a mounting plate is placed between the two sidewalls, and the mounting plate defines a mounting portion for the safety door, wherein the driving device is received in the mounting portion.

13. The food dispensing device of claim 12, wherein a top end of each sidewall is provided with a supporting plate, a middle portion of the supporting plate defines a gap, and a top end of the driving shaft passes through the gap.

14. The food dispensing device of claim 13, wherein a top end of the driving shaft is provided with a positioning member, the positioning member defines a pivot hole and is secured above the supporting plate by a plurality of securing member, the top end of the driving shaft can pass through the gap of the supporting plate to be rotatably installed on the pivot hole of the positioning member.

15. The food dispensing device of claim 11, wherein a top end of the board is provided with a latch plate, and the latch plate is provided with a hollow shaft sleeve, an inside of the shaft sleeve defines internal threads, an outside of the driving shaft defines external threads, the driving shaft passes through the shaft sleeve such that the internal threads engage with the external threads.

16. The food dispensing device of claim 11, wherein the cover comprises two columns, each column is provided with a bracket, each bracket is provided with two slide rails, and the board slides along the two slide rails.

17. The food dispensing device of claim 16, wherein each side of the board includes a limiting shaft, and the limiting shaft can be inserted into the slide rail for the board to slide along the slide rail.

18. The food dispensing device of claim 11, wherein the inside of the driving device includes a chip, and the chip is configured to receive a signal from the processing module secured in the safety door to control the motor to rotate.

19. The food dispensing device of claim 18, wherein a predetermined value is set in the chip, and when output power of the motor exceeds the predetermined value, the chip will control the motor to rotate in second direction opposite to the first direction to slide the board to its initial position.
